(19) United States
(12) Patent Application Publication
(10) Pub. No.: US 2022/0061386 A1
(43) Pub. Date: Mar. 3, 2022

(54) CERAMIC ATOMIZER

(71) Applicant: Shenzhen Eigate Technology Co., Ltd., Shenzhen (CN)

(72) Inventor: Tuanfang LIU, Shenzhen (CN)

(21) Appl. No.: 17/125,996

(22) Filed: Dec. 17, 2020

(30) Foreign Application Priority Data
Aug. 25, 2020 (CN) 202010864557.5
Aug. 25, 2020 (CN) 202021795525.6

(51) Int. Cl. A24F 40/46; H05B 1/02

(52) U.S. Cl. CPC A24F 40/46; A24F 40/10; H05B 1/0297

(57) ABSTRACT

A ceramic atomizer includes a ceramic core and a heating wire. The ceramic core includes a concave bottom end and the heating wire is secured to the concave bottom end.

### CROSS-REFERENCE TO RELATED APPLICATIONS

Pursuant to 35 U.S.C. § 119 and the Paris Convention Treaty, this application claims foreign priority to Chinese Patent Application No. 202010864557.5 filed on Aug. 25, 2020, and to Chinese Patent Application No. 202021795525.6 filed on Aug. 25, 2020. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a ceramic atomizer.

Conventionally, a ceramic atomizer comprises a ceramic core and a heating wire. The ceramic core is a cylinder comprising one or two through holes and the heating wire passes through the through holes to be secured to the ceramic core. In this way, the e-liquid in the ceramic core directly contacts the heating wire and tends to deposit on the heating wire to form stains.

### SUMMARY

The disclosure provides a ceramic atomizer, comprising a ceramic core and a heating wire; the ceramic core comprises a concave bottom end and the heating wire is secured to the concave bottom end.

In a class of this embodiment, the heating wire comprises a first part secured to the concave bottom end and a second part extending from the first part to form a pin.

In a class of this embodiment, the heating wire is two in number; the two heating wires are coiled into two planes respectively on the bottom end of the ceramic core side by side and are connected in parallel; the two heating wires each comprise two pins.

In a class of this embodiment, the ceramic core is cylindrical, and the heating wire is bended back and forth to form a planar disk secured to the ceramic core.

In a class of this embodiment, the heating wire comprises more than two alloy wires, in the shape of planar screen, mesh, or lattice, and secured to the ceramic core in parallel or in series.

### BRIEF DESCRIPTION OF THE DRAWINGS

FIG. 1 is a schematic diagram of a ceramic atomizer in accordance with one embodiment of the disclosure;

FIG. 2 is another schematic diagram of a ceramic atomizer in accordance with one embodiment of the disclosure; and

FIG. 3 is a sectional view of a ceramic atomizer in accordance with one embodiment of the disclosure.

### DETAILED DESCRIPTION

To further illustrate, embodiments detailing a ceramic atomizer are described below. It should be noted that the following embodiments are intended to describe and not to limit the disclosure.

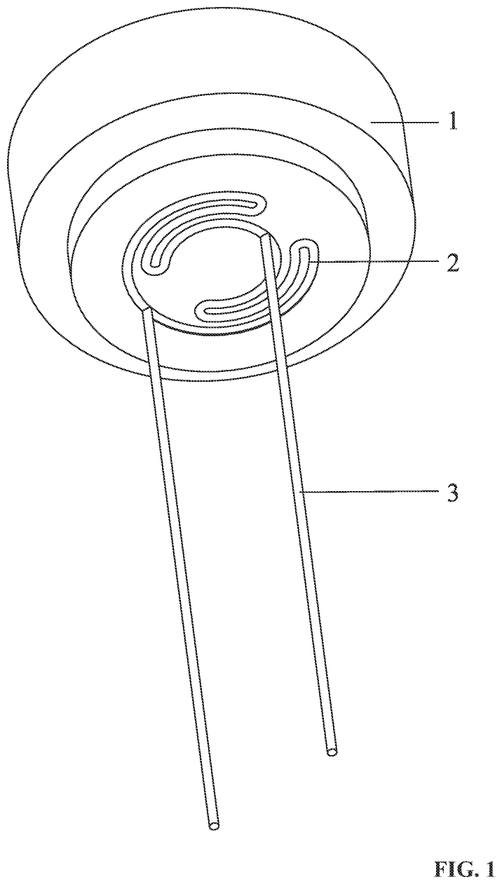

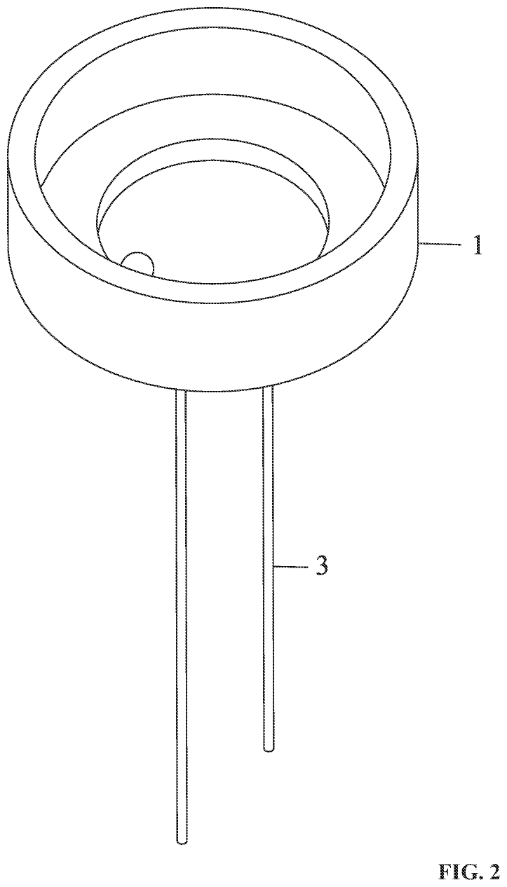

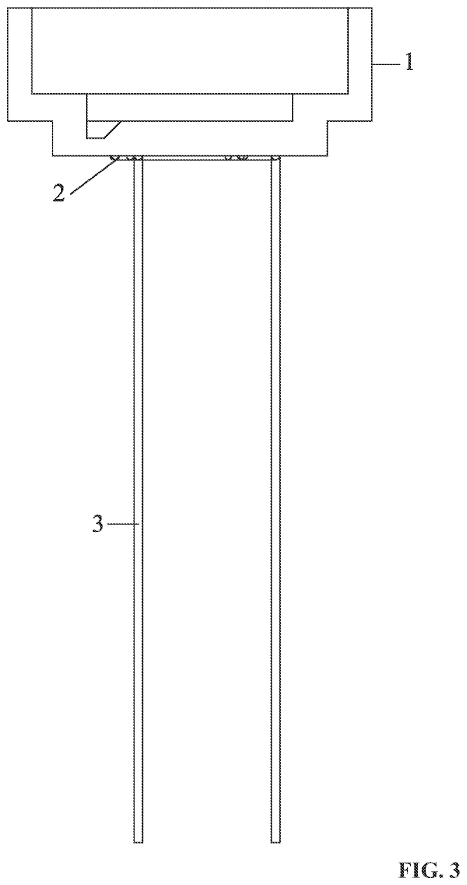

As shown in FIGS. 1-3, the disclosure provides a ceramic atomizer comprising a ceramic core 1 and a heating wire 2. The ceramic core 1 is a cylinder comprising a concave bottom end. The heating wire 2 is a disk-shaped planar wire disposed on the concave bottom end of the ceramic core. The ceramic core 1 comprises two pins 3 extending from the concave bottom end of the ceramic core 1. The two pins 3 are electrically connected to the heating wire 2 so as to heat the heating wire 2. The heating wire transfers the heat to the ceramic core 1 to atomize the e-liquid in the concave bottom end. In this way, the e-liquid does not directly contact the heating wire 2, so no stain deposits on the heating wire 2.

In certain embodiments, the ceramic core 1 is replaced with quartz, crystal, mica, jade and other materials. The ceramic core 1 is square, hemispherical, conical, polygonal and comprises the concave bottom end. The heating wire 2 comprises two or more planar or square disk-shaped or mesh-shaped metal wires, disposed under the bottom end of the ceramic core 1 or surrounds the ceramic core 1.

The following advantages are associated with the ceramic atomizer of the disclosure:

1. The ceramic core is cylindrical and comprises a concave bottom end, and the ceramic core is thermal conductive. After the heating wire is electrified, the heat is transferred to the ceramic core to atomize the e-liquid of the electronic cigarette. The ceramic core has a large contact area with the e-liquid.

2. The heating wire is bended back and forth to form a planar disk secured to the ceramic core. The design is novel.

3. The heating wire comprises more than two alloy wires secured to the ceramic core in parallel or in series, thus improving the heating efficiency.

It will be obvious to those skilled in the art that changes and modifications may be made, and therefore, the aim in the appended claims is to cover all such changes and modifications.

What is claimed is:

1. A device, comprising a ceramic core and a heating wire; wherein the ceramic core comprises a concave bottom end and the heating wire is secured to the concave bottom end.

2. The device of claim 1, wherein the heating wire comprises a first part secured to the concave bottom end and a second part extending from the first part to form a pin.

3. The device of claim 2, wherein the heating wire is two in number; two heating wires are coiled into two planes respectively on the concave bottom end of the ceramic core side by side and are connected in parallel; the two heating wires each comprise two pins.

4. The device of claim 3, wherein the ceramic core is cylindrical, and the heating wire is bended back and forth to form a planar disk secured to the ceramic core.

5. The device of claim 4, wherein the heating wire comprises more than two alloy wires, in the shape of planar screen, mesh, or lattice, and secured to the ceramic core in parallel or in series.
